(19) United States
(12) Patent Application Publication
(10) Pub. No.: US 2014/0362088 A1
(43) Pub. Date: Dec. 11, 2014

(54) GRAPHICAL DISPLAY OF RADAR AND RADAR-LIKE METEOROLOGICAL DATA

(71) Applicants: Mark S. Veillette, Wilmington, MA (US); Marilyn M. Wolfson, Acton, MA (US); Haig Iskenderian, Arlington, MA (US); Christopher Mattioli, Waltham, MA (US); Earle R. Williams, Brookline, MA (US)

(72) Inventors: Mark S. Veillette, Wilmington, MA (US); Marilyn M. Wolfson, Acton, MA (US); Haig Iskenderian, Arlington, MA (US); Christopher Mattioli, Waltham, MA (US); Earle R. Williams, Brookline, MA (US)

(73) Assignee: MASSACHUSETTS INSTITUTE OF TECHNOLOGY, Cambridge, MA (US)

(21) Appl. No.: 14/290,308

(22) Filed: May 29, 2014

Related U.S. Application Data
(60) Provisional application No. 61/831,791, filed on Jun. 6, 2013.

(51) Int. Cl. G06T 11/20

(52) U.S. Cl. CPC G06T 11/20
USPC 345/441

(57) ABSTRACT

Described are a method and a system for generating a weather radar display. The method includes determining proxy meteorological radar data for a first area of a geographical region for which meteorological radar data are unavailable. The proxy data are determined from a plurality of alternative meteorological data streams each having data representative of a value of a different meteorological parameter that is not observable by radar. The method further includes determining graphical meteorological radar data for the geographical region based on the proxy meteorological radar data for the first area in the geographical region and meteorological radar data for a second area in the geographical region. Examples of graphical meteorological radar data that are generated include vertically integrated liquid, composite reflectivity and echo tops data.

### RELATED APPLICATIONS

This application claims the benefit of the earlier filing date of U.S. Provisional Patent Application No. 61/831,791, filed Jun. 6, 2013 and titled “Global Radar and Radar-Like Weather Depiction,” the entirety of which is incorporated herein by reference.

### GOVERNMENT RIGHTS IN THE INVENTION

This invention was made with government support under Contract No. FA8721-05-C-0002 awarded by the U.S. Air Force. The government has certain rights in the invention.

### FIELD OF THE INVENTION

The present invention relates generally to a method and system for display of weather data. More particularly, the invention relates a method of generating a display that includes meteorological radar data and proxy meteorological data for a geographical region.

### BACKGROUND OF THE INVENTION

The need for accurate short-term weather predictions is necessary for business, government and individuals. In one particular example, short-term forecasts are necessary for air traffic management. Convective weather can be difficult to predict out more than a few hours and in some instances can change significantly in less than an hour. Unexpected convective weather can result in a reduction in airspace capacity thus weather radar is an important tool for managing air traffic in regions where convective weather is present.

Weather radar data are available from a variety of sources, including by way of specific examples, NEXRAD (Next-Generation Radar) and TWDR (Terminal Weather Doppler Radar) sources. Although these sources provide nearly complete geographical coverage over the eastern portion of the United States, areas of degraded and non-existent coverage exist offshore and in the mountainous western portion of the United States due in part to terrain blockage. Moreover, there is a significant absence of weather radar coverage for many other areas of the world.

On occasion, normally-available weather radar data may become unavailable due to equipment problems and communication disruptions. Thus weather radar images may not be available on occasion for users requiring data for situational awareness and tactical planning.

### SUMMARY

In one aspect, the invention features a method for generating a weather radar display. The method includes determining, at a processor module, proxy meteorological radar data for a first area of a geographical region for which meteorological radar data are unavailable. The proxy meteorological radar data are determined from a plurality of alternative meteorological data streams. Each alternative meteorological data stream includes data representative of a value of a meteorological parameter that is not observable by radar and that is different from the meteorological parameters of the other alternative meteorological data streams. The method also includes determining, at the processor module, graphical meteorological radar data for the geographical region in response to the proxy meteorological radar data for the first area in the geographical region and meteorological radar data for a second area in the geographical region.

In another aspect, the invention features a system for generating graphical meteorological radar data. The system includes a processor module configured to receive meteorological radar data associated with a first area of a geographical region and to receive a plurality of alternative meteorological data streams associated with a second area of the geographical region for which meteorological radar data are unavailable. The processor module is configured to determine proxy meteorological radar data for the second portion of the geographical region based on the plurality of alternative meteorological data streams. Each alternative meteorological data stream includes data representative of a value of a meteorological parameter that is not observable by radar and that is different from the meteorological parameters of the other alternative meteorological data streams. The processor module is further configured to generate graphical meteorological data for the geographical region based on the meteorological radar data and the proxy meteorological radar data.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is a block diagram of an embodiment of a system for generating graphical meteorological radar data for a weather radar display.

FIG. 2 is a flowchart representation of an embodiment of a method for generating a weather radar display.

FIG. 3 is a display of Vertically Integrated Liquid (VIL) data for a geographical region.

FIG. 4 is a display in which proxy VIL data calculated from alternative meteorological data streams are displayed for the geographical region shown in FIG. 3.

FIG. 5 is a display of Echo Tops (ET) data for a geographical region.

FIG. 6 is a display in which proxy ET data calculated from alternative meteorological data streams are displayed for the geographical region of FIG. 5.

FIG. 7 is an image of ET data for a geographical region in which ET data are unavailable for a portion of the region.

FIG. 8 is a display generated according to one embodiment of a method for generating a weather radar display and is based upon a combination of ET data and proxy ET data.

### DETAILED DESCRIPTION

In brief overview, the invention relates to a method and a system for generating a weather radar display. According to various embodiments of the method, radar-like depictions of weather for geographical areas where weather radar coverage is degraded or unavailable are generated and combined with radar-based weather depictions. The radar-based weather depictions utilize meteorological radar data such as Vertically Integrated Liquid (VIL) data, Composite Reflectivity data, Echo Tops (ET) data and other types of meteorological data that can be derived directly from acquired radar measurement data. The VIL data and Composite Reflectivity data generally correlate with updraft strength and precipitation intensity, and the ET data indicate a maximum cloud height for a specified level of return radar signal.

Radar-like weather data, that is, proxy meteorological radar data are determined from alternative meteorological data streams that include data for meteorological parameters which are not observable by radar. As used herein, proxy meteorological radar data means data that are derived or calculated from acquired atmospheric data obtained without the use of radar although the proxy meteorological radar data may represent the same type of meteorological data that are derived by direct measurement of the atmosphere using weather radar. Examples of alternative meteorological data streams used to generate the proxy meteorological radar data include visible and infrared image data from satellites, lightning flash data, and numerical weather prediction model data. Examples of radar-like proxy data generated by the method include calculated VIL data, calculated composite reflectivity data and/or calculated ET data, and may include other types of meteorological radar data that can be calculated from non-radar measurements and observations of the atmosphere. VIL data, Composite Reflectivity, ET data or other meteorological radar data derived from actual radar measurements are combined with proxy meteorological radar data of the same type to produce a hybrid graphical depiction of weather conditions. In various embodiments, the hybrid depiction is a global depiction. The weather depiction can be provided in the form of a hazardous radar-like weather display or other forms of display generated with additional image processing.

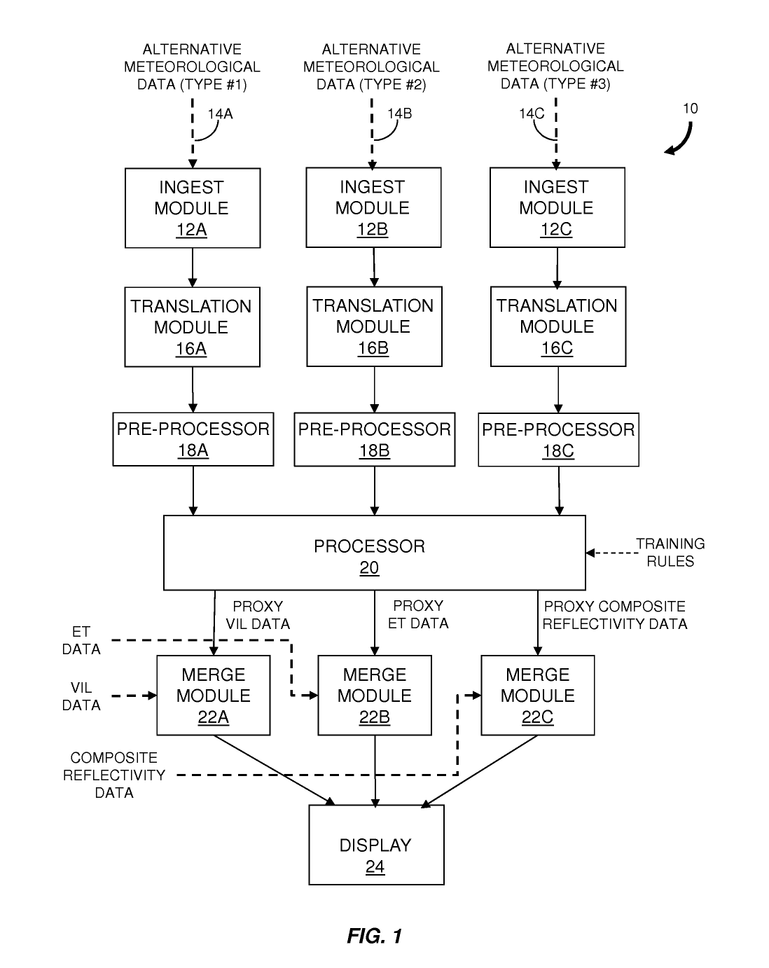

FIG. 1 is a functional block diagram of an embodiment of a system 10 for generating graphical meteorological radar data for a weather radar display. The system 10 includes a number of ingest modules 12 each configured to receive a stream of alternative meteorological data of a particular type transmitted over a communications channel 14. As used herein, a data stream means any flow of data such as a sequence of digital data packets used to transmit information, for example, the values of a meteorological parameter for locations within a geographical region. The data streams may be asynchronous or synchronous, and conform to various data protocols as is known in the art. The data streams may include data for different sized geographical areas and may be provided at different update rates. Although three streams of alternative meteorological data are shown, it should be recognized that any plurality of alternative meteorological data streams can be used. By way of specific non-limiting examples, an ingest module 12 can be a satellite receiver system configured to receive data transmitted from a satellite or a digital data communications module configured to receive digital data transmitted over a data network.

Each ingest module 12 provides its received data stream to a corresponding translation module 16 so that the data are converted to a grid format. The grid data sets are provided to respective pre-processors 18 where various image processing operations are performed, including, but not limited to, spatial and temporal filtering, adjustment for parallax error, change of coordinates, and image normalization prior to subsequent processing. In addition, the grid data sets may have different update rates based on the corresponding update rates of the alternative meteorological data streams, and hence motion compensation and time alignment of certain input fields may be performed to account for storm motion. The pre-processors 18 operate to achieve spatial and temporal commonality for pixels in the different grid data sets.

The grid data sets from the pre-processors 18 are provided to a processor 20 where various features associated with each pixel of the sets of grid data are calculated. For example, the features may be based on predefined pixel kernels and mathematical functions, such as local minimum, maximum, standard deviation and percentile values. Using established training rules, the processor 20 determines proxy meteorological radar data based on the calculated pixel features. Proxy meteorological radar data of a certain type are provided to a corresponding merge module 22 where the data are processed in combination with meteorological radar data of the same type to generate graphical meteorological radar data of that type for presentation on a display 24. For example, merge module 22A receives VIL data from an external data source and proxy VIL data from the processor 20, and generates graphical VIL data that includes VIL data and proxy VIL data, and may optionally include additional data that is a blend or weighted combination of the VIL data and proxy VIL data, as described below. In one alternative embodiment, the meteorological radar data may be derived locally, for example, from raw radar volume data provided to the processor 20 from one or more radars in a weather radar network. Thus both the meteorological radar data (e.g., VIL data) and proxy meteorological radar data (e.g., proxy VIL data) are provided from the processor 20 to the merge module 22 in this alternative embodiment.

The translation modules 16, pre-processors 18, processor 20 and merge modules 22 may be realized using a single processor module or as a combination of processors. For example, the processor module or multiple processors may include one or more CPUs in a personal computer (PC) or workstation. The system 10 may also include one or more memory modules to buffer or temporarily store the data during transfer between modules and processor components.

Alternatively, more complex processor configurations that include multiple computational nodes may be used. For example, the computation nodes may be a network of PCs or workstations. Large geographical regions may make it preferable to utilize a network of computational nodes to allow for parallel data processing and image processing. For example, a geographical domain may be divided into smaller sub-domains for processing in parallel at respective computational nodes.

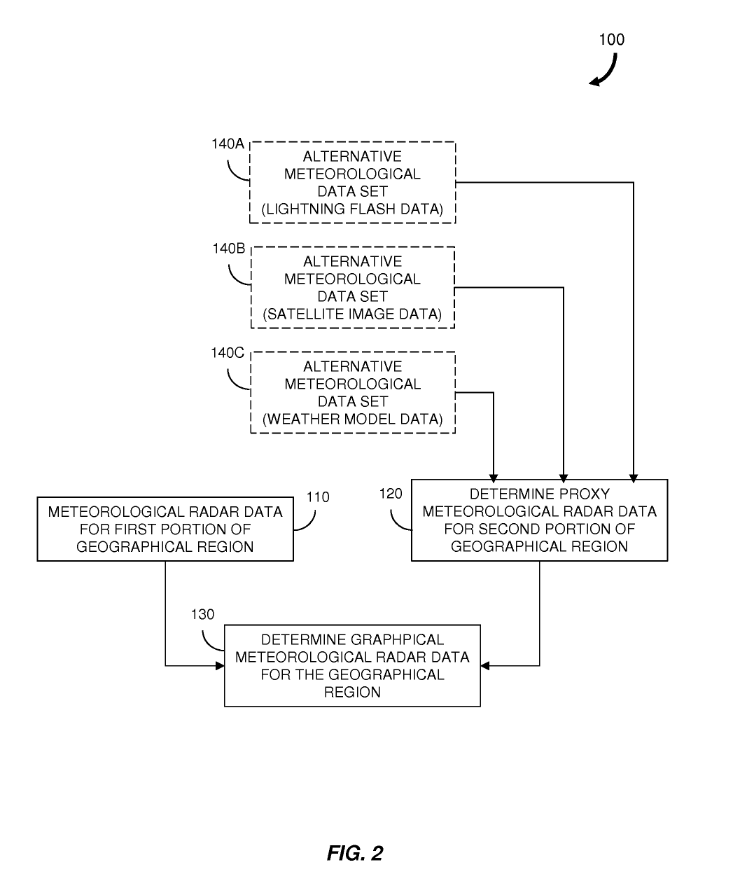

FIG. 2 shows a flowchart representation of an embodiment of a method 100 for generating a weather radar display. The method includes acquiring 110 meteorological radar data for a first area in a larger geographical region for which weather radar data and weather radar-like data are to be displayed.

The method 100 also includes determining 120 proxy meteorological radar data for a second area in the geographical region in which meteorological radar data are unavailable or degraded. For example, the second area may be too distant for the atmosphere to be observed by existing weather radar facilities or may be an area in which terrain obscures atmospheric observation by existing facilities. The proxy meteorological radar data can be determined from a combination of any number of alternative meteorological data streams 140A, 140B and 140C. By way of a limited example, three alternative meteorological data streams 140 are shown; however, any combination of two or more alternative meteorological data streams can be used.

Lightning flash data is one type of alternative meteorological data that can be used to generate proxy meteorological data. Lightning flash data may be provided in data packets delivered periodically (e.g., 15 second intervals) and may be obtained with substantially global coverage. The lightning flash data indicate the locations of lightning flashes that occur within the observation period. For example, lightning flash data are commercially available from Earth Networks Total Lightning Network of Germantown, Maryland and via Vaisala Global Lightning Dataset GLD360 service available from Vaisala of Finland. In some embodiments, lightning flash data may include data for both cloud-to-ground lightning strikes as well as in-cloud lightning flashes.

Lightning flash data can be used to generate proxy meteorological radar data, for example, by determining the number of flashes in a fixed duration window that occur within a unit size geographical area and comparing this lightning flash rate with the corresponding VIL or ET data obtained for the same time window and geographical area. A relationship between lightning flash rate and VIL is then constructed using a probability matching method trained on data collected over a large geographical region. While this technique generates useful VIL and ET proxy data, it is generally limited to the training geographical area and in the type of storms that can be identified. More specifically, only storms with significant lightning flash rates are readily identified.

Satellite image data is another type of alternative meteorological data that can be used to generate proxy meteorological radar data. Satellite image data can be acquired using a satellite receiver antenna or from other sources such as the National Oceanic and Atmospheric Administration's Comprehensive Large Array Stewardship System (NOAA CLASS) or the Space Science and Engineering Center (SSEC) from the University of Wisconsin. Sources of satellite image data include geostationary satellites such as the Geostationary Operational Environmental Satellite (GOES) platforms (e.g., GOES-East and GOES-West for continental U.S. coverage). Satellites can provide a number of channels which can indicate potential locations of convection. For example, GOES satellite data are available in visible and multiple infrared bands (3.9 μm, 6.7 μm, 10.7 μm and 13.3 μm bands). It is generally difficult for human forecasters to determine thunderstorm location and severity based on visible and IR satellite imagery alone.

Interest images can be derived from the satellite image data in the various spectral bands and used to derive VIL data independent of radar measurement data. The derived VIL data can be used to generate a radar-like weather depiction for a given time and these depictions can be useful for identifying regions of convective weather.

Numerical weather prediction models provide another type of alternative meteorological data. By way of a specific example, numerical model data are available from the Global Forecast System (GFS) model operated by the National Oceanic and Atmospheric Administration (NOAA). Depiction of storm location, intensity, and vertical extent from numerical weather prediction models can improve awareness of oceanic convection. The GFS model provides a 0.5° global numerical output which can be used for this purpose. Storms present in the model data are used to identify potentially hazardous storm cells and events, and to provide measures of intensity and storm type (e.g., tropical cyclones or hurricanes, and tropical convective clusters). The Rapid Refresh (RAP) model is an example of another numerical weather prediction model that can be used. The RAP model provides hourly data for most of the North American continent with 13 km horizontal resolution.

The determination 120 of proxy meteorological radar data using several different meteorological data streams enables graphical presentation of weather conditions according to conventional radar-observable data types such as VIL data, composite reflectivity data and ET data. The proxy meteorological radar data and meteorological radar data are used in the determination 130 of graphical meteorological radar data for display to a user. Advantageously, the determination of proxy meteorological radar data can be used to supplement existing weather radar data coverage to provide a global weather radar display.

To generate a model that can create the proxy meteorological radar data, a training set is constructed containing the predictors which may include features derived from one or more spectral bands of satellite image data, lightning flash data and numerical model storm structure, intensity and location. Features comprise a set of image filters applied to input images. Examples of applied image filters include a local minimum, maximum, standard deviation or percentile measured within a kernel of a specified radius around each pixel of the input image. Features are computed at each pixel of each input image obtained from the satellite, lightning, and model input images. A predictand, such as radar measurement data for VIL, composite reflectivity and ET for land areas having radar coverage and for selected oceanic storms, is associated with each predictor. The selected oceanic storms may include those observed by the National Aeronautics and Space Administration (NASA) Tropical Rainfall Measuring Mission (TRMM) satellite which has an on-board precipitation radar. Using the training set, a machine learning model is trained to predict VIL data, composite reflectivity data and ET data. A number of machine learning methods can be trained and combined to produce the final model. These methods include, but are not limited to, random forests, support vector machines and neural networks.

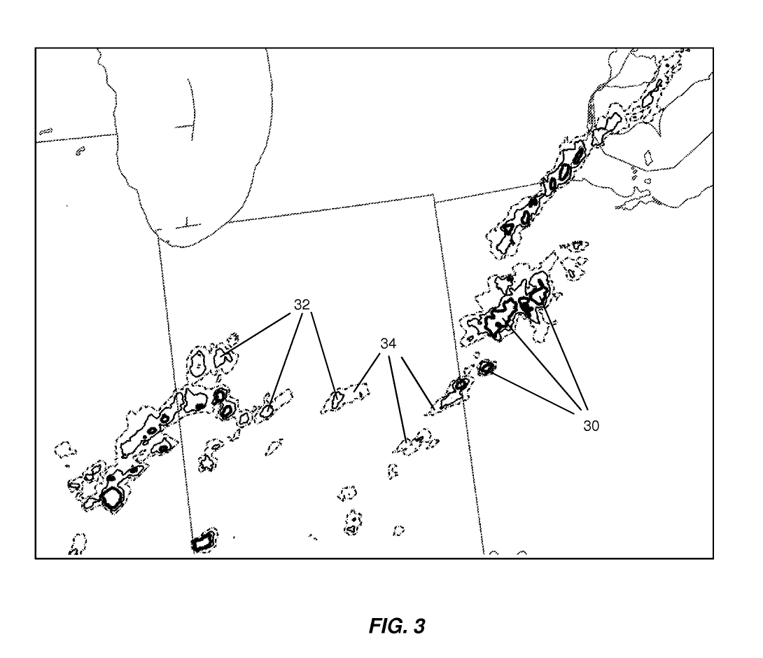

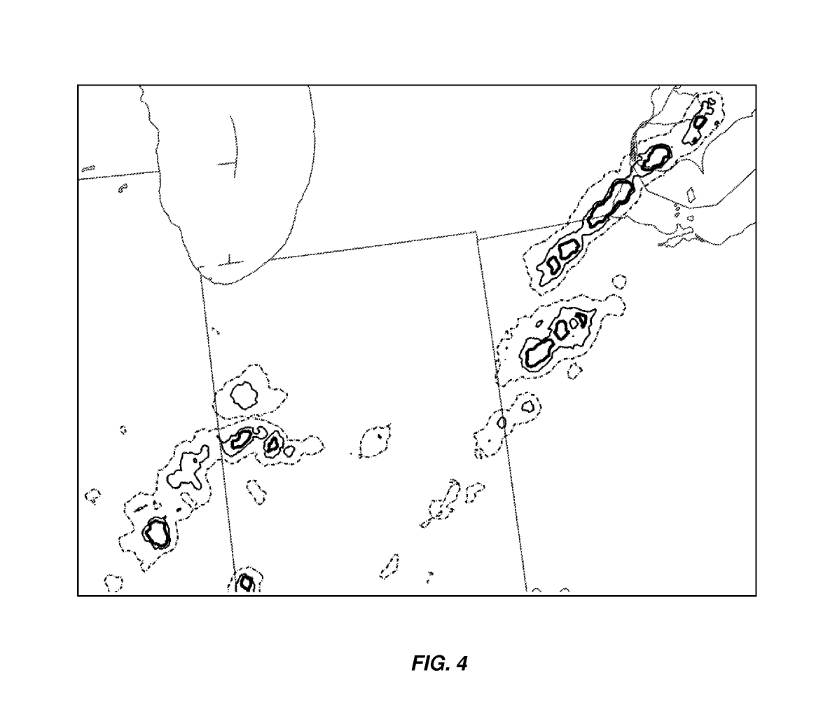

FIG. 3 shows a weather radar display of VIL data for portions of several U.S. midwestern states, including Illinois, Indiana, Michigan and Ohio. The display is generally provided for viewing in a color format such as by depicting low and moderate VIL values using multiple shades of green, with high to severe VIL values indicated by various shades of yellow, orange and red as is known to those of skill in the art. In FIG. 3, severe VIL values (e.g., regions 30) are enclosed by a thick solid contour line, high VIL values (e.g., regions 32) are enclosed within a thin solid contour line (excluding any regions containing the severe VIL values), and moderate VIL values (e.g., regions 34) are enclosed within a thin dashed contour line (excluding any regions containing the high and severe VIL values). FIGS. 4 through 8 described below indicate relative VIL or ET values using the same contour line format.

FIG. 4 shows a weather radar display of VIL for the same geographical region shown in FIG. 3 using only the proxy meteorological radar data calculated from alternative meteorological data streams. The fine spatial structure of the VIL image in FIG. 3 is not evident in the proxy VIL image of FIG. 4; however, the regions of high and severe proxy VIL values exhibit a high degree of correspondence to similar regions in the VIL image of FIG. 3.

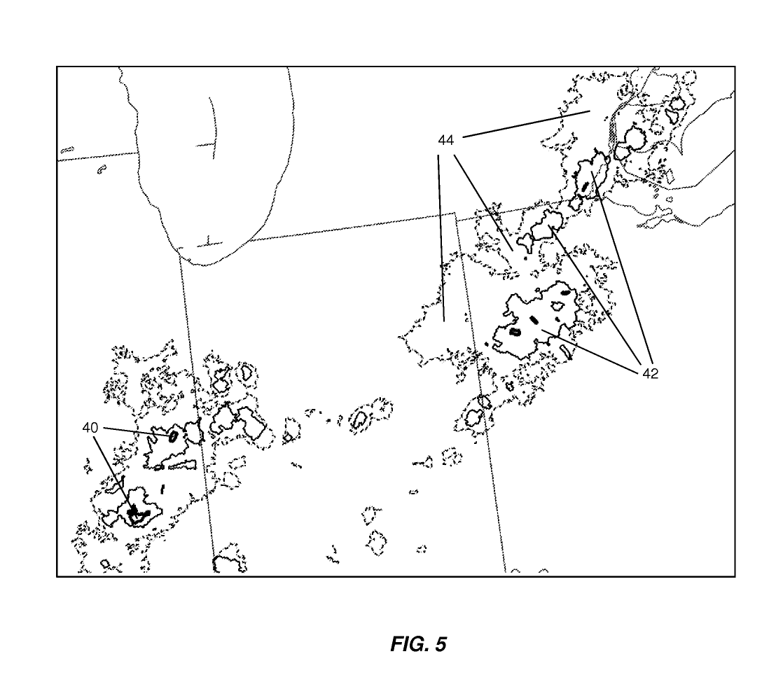

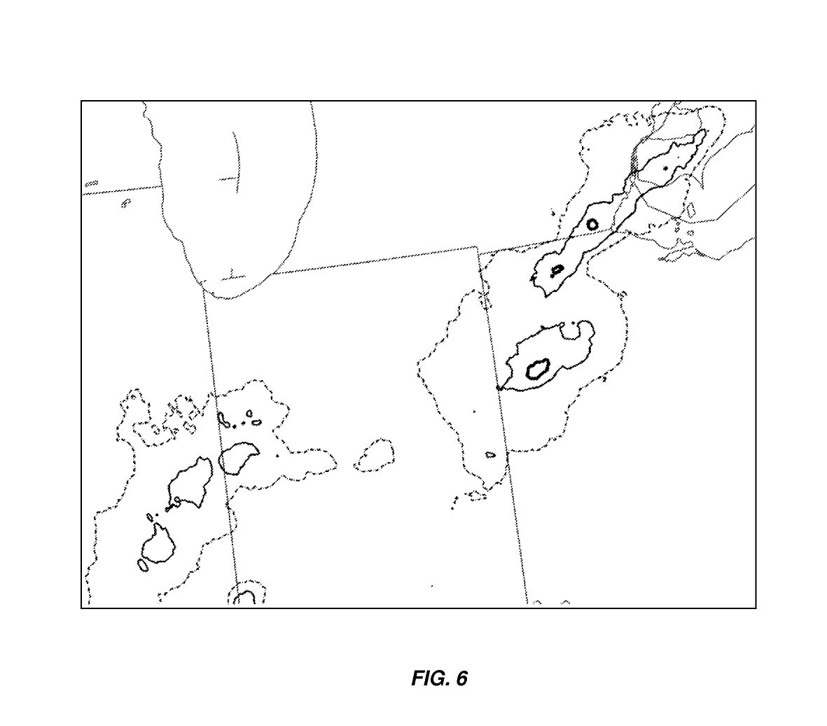

FIG. 5 shows a weather radar display of ET data based on radar measurement data and includes regions of severe ET values (e.g., regions 40), high ET values (e.g., regions 42) and moderate ET values (e.g., regions 44). FIG. 6 shows a weather radar display of ET similar to the display of FIG. 5 except that the displayed data are proxy ET data derived from alternative meteorological data streams. The correlation of ET data is evident between the images of FIGS. 5 and 6, especially for regions of severe and high ET values.

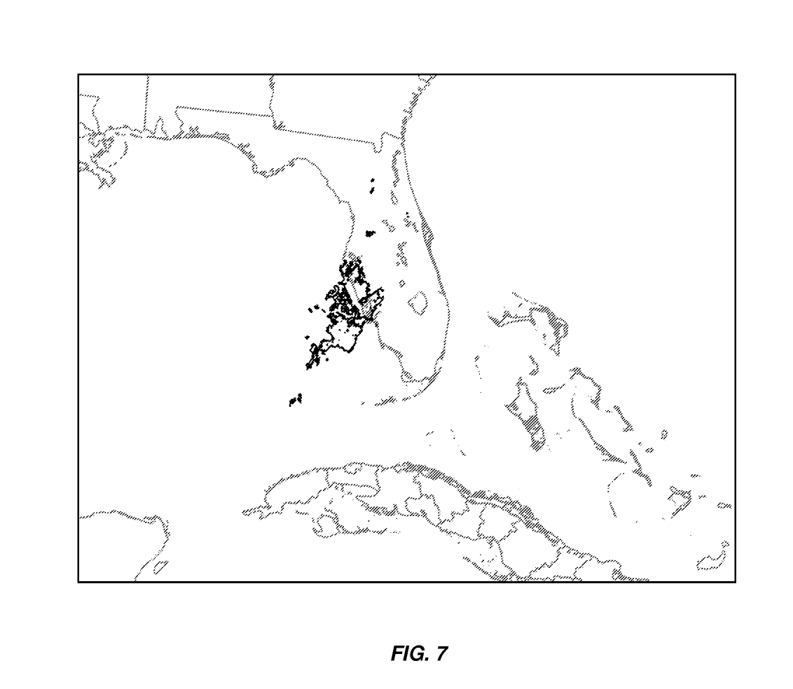

FIG. 7 shows a weather radar display of ET data for a geographical region that includes Florida, portions of neighboring states and Cuba. High ET values are evident along portions of the west coast of the lower peninsula of Florida and nearby offshore regions, while moderate ET values are shown further north and east. No ET data are displayed for regions that are out of range of U.S. land-based weather radar.

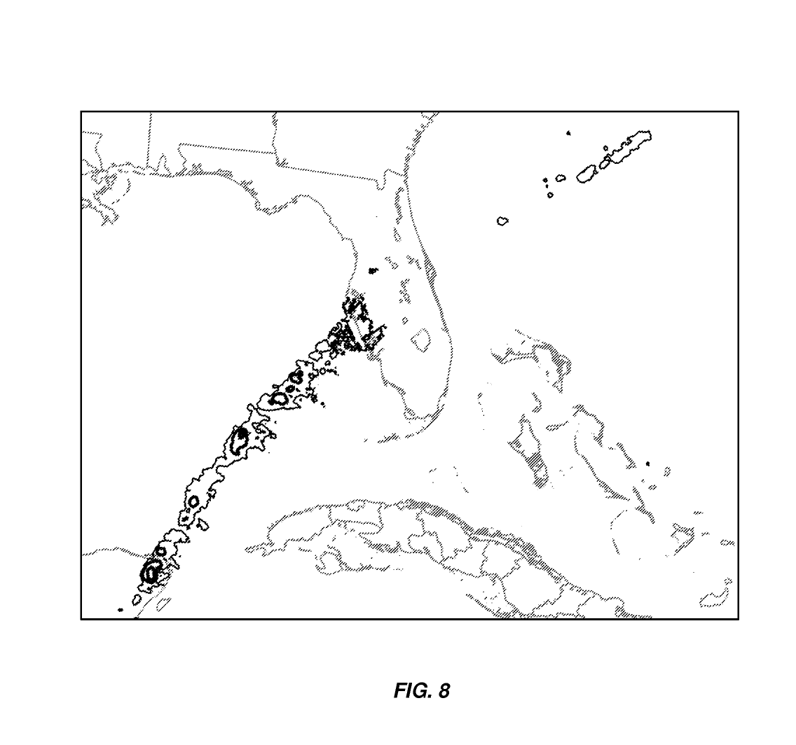

FIG. 8 is an image generated according to one embodiment of the method for generating a weather radar display. The image is based upon a combination of ET data and proxy ET data, and presents a full coverage of weather conditions for the entire depicted geographical area. The displayed data are generated in three different formats. One area in the image, corresponding to the U.S. mainland and nearby waters, includes ET data determined directly from weather radar measurements and includes displayed data that are similar to the displayed ET data in FIG. 7. A second area in the image, in regions beyond the coverage of U.S weather radar facilities due, includes proxy ET data that are determined solely from alternative meteorological data sources. Lack of coverage may be due to excessive distance from the weather radar facility such that return radar signals are too weak or so that lower altitudes cannot be adequately observed by the closest weather radar facility. A third area in the image is an overlap region that “transitions” between the first and second area, and includes data that are calculated as a weighted combination of ET data and proxy ET data. The weighting can be defined in a variety of ways. For example, weighting may be determined according to distance from one or more of the land-based weather radar facilities. Locations in the overlap region that are nearer to radar facilities have a greater weighting of the ET data while more distant locations within the overlap region have a greater weighting of the proxy ET data. Display of the weighted combination of ET and proxy ET data in the overlap region provides a smoother or seamless transition between the other areas in the image and results in a more easily interpretable image for a viewer.

While the invention has been shown and described with reference to specific embodiments, it should be understood by those skilled in the art that various changes in form and detail may be made therein without departing from the spirit and scope of the invention.

What is claimed is:

1. A method for generating a weather radar display, the method comprising:
determining, at a processor module, proxy meteorological radar data for a first area of a geographical region for which meteorological radar data are unavailable, the proxy meteorological radar data being determined from a plurality of alternative meteorological data streams, each one of the alternative meteorological data streams comprising data representative of a value of a meteorological parameter that is not observable by radar and that is different from the meteorological parameters of the other alternative meteorological data streams; and
determining, at the processor module, graphical meteorological radar data for the geographical region in response to the proxy meteorological radar data for the first area in the geographical region and meteorological radar data for a second area in the geographical region.

2. The method of claim 1 wherein the first and second areas of the geographical region include an overlap region.

3. The method of claim 2 wherein graphical meteorological radar data for the overlap region are generated in response to a combination of the proxy meteorological radar data and meteorological radar data for the overlap region.

4. The method of claim 1 further comprising generating a display of the graphical meteorological radar data.

5. The method of claim 1 wherein the meteorological radar data are vertically integrated liquid data.

6. The method of claim 1 wherein the meteorological radar data are composite reflectivity data.

7. The method of claim 1 wherein the meteorological radar data are echo tops data having values that indicate a maximum cloud height for a specified level of radar return signal.

8. The method of claim 1 wherein one of the alternative meteorological data streams comprises satellite data for at least one spectral band.

9. The method of claim 1 wherein one of the alternative meteorological data streams comprises numerical weather prediction model data.

10. The method of claim 1 wherein one of the alternative meteorological data streams comprises lightning flash data.

11. The method of claim 1 wherein the geographical region is a global region.

12. The method of claim 2 wherein the graphical meteorological radar data corresponding to the overlap region are determined from a weighted combination of the proxy meteorological radar data and meteorological radar data.

13. A system for generating graphical meteorological radar data, comprising:
a processor module configured to receive meteorological radar data associated with a first area of a geographical region and to receive a plurality of alternative meteorological data streams associated with a second area of the geographical region for which meteorological radar data are unavailable, the processor module configured to determine proxy meteorological radar data for the second portion of the geographical region based on the plurality of alternative meteorological data streams, each one of the alternative meteorological data streams comprising data representative of a value of a meteorological parameter that is not observable by radar and that is different from the meteorological parameters of the other alternative meteorological data streams, the processor module further configured to generate graphical meteorological data for the geographical region in response to the meteorological radar data and the proxy meteorological radar data.

14. The system of claim 13 further comprising a display in communication with the processor module to display the graphical meteorological data for the geographical region to a user.
